(19) United States
(12) Patent Application Publication
(10) Pub. No.: US 2026/0113765 A1
(43) Pub. Date: Apr. 23, 2026

(54) SIDELINK BEAM ALIGNMENT WITH INTER-UE COORDINATION

(71) Applicant: TOYOTA JIDOSHA KABUSHIKI KAISHA, Toyota-shi, Aichi-ken (JP)

(72) Inventors: Daniel MEDINA, Munchen (DE); Nuno KIILERICH PRATAS, Gistrup (DK); Torsten WILDSCHEK, Gloucester (GB); Ling YU, Kauniainen (FI); Jun TAN, Glenview, IL (US); Takayuki SHIMIZU, Mountain View, CA (US); John KENNEY, Mountain View, CA (US); Onur ALTINTAS, Mountain View, CA (US); Hongsheng LU, Mountain View, CA (US); Chang-Yi LUO, Tokyo (JP)

(73) Assignee: TOYOTA JIDOSHA KABUSHIKI KAISHA, Toyota-shi, Aichi-ken (JP)

(21) Appl. No.: 19/117,053

(22) PCT Filed: Sep. 29, 2023
(86) PCT No.: PCT/JP2023/035614

§ 371 Date: Mar. 30, 2025

Related U.S. Application Data
(60) Provisional application No. 63/377,538, filed on Sep. 29, 2022.

(51) Int. Cl. H04W 72/40

(52) U.S. Cl. CPC H04W 72/40

(57) ABSTRACT

A method includes: receiving, by a first UE in a sidelink communication, an inter-UE coordination (IUC) signal transmitted from a second UE; determining a set of candidate radio resources for communication with the second UE based on the IUC signal; determining at least one direction associated with the IUC signal based on an estimated angle-of-arrival of the IUC signal; selecting, among a plurality of beams, at least one beam for communication with the second UE based on at least one of the determined at least one direction or a content of the IUC signal; determining a subset of radio resources from the set of candidate radio resources based on sensing on the selected at least one beam; and transmitting the determined subset of radio resources to the second UE, or selecting from the determined subset of radio resources, one or more radio resources for communication with the second UE.

### CROSS-REFERENCE TO RELATED PATENT APPLICATION

This application claims the benefit of U.S. Provisional Application No. 63/377,538, filed on Sep. 29, 2022, entitled “SIDELINK BEAM ALIGNMENT WITH INTER-UE COORDINATION,” the entirety of which is incorporated by reference herein.

### TECHNICAL FIELD

Apparatuses and methods consistent with the present disclosure relate generally to communications, more specifically, methods, systems, and devices for beam alignment in sidelink communications.

### BACKGROUND ART

Sidelink communication technology enables direct communication between two or more devices, for example, two or more vehicles in a vehicle-to-everything (V2X) communication.

3rd Generation Partnership Project (3GPP) Release 16/17 5G NR sidelink modes 1 and 2 are specified in 3GPP TS 38.211, TS 38.212, TS 38.213, TS 38.214, TS 38.215, TS 38.321, TS 38.322, TS 38.323, and TS 38.331.

In Release 17, inter-user equipment (UE) coordination (IUC) is introduced for 5G NR sidelink mode 2, in which a UE-A sends coordination information about resources to a UE-B, and then
the UE-B utilizes that information for its resource
(re-)selection. Two schemes of IUC are supported.

In IUC scheme 1, a UE-A can provide to another UE, UE-B, indications of resources that are preferred to be included in UE-B's (re-)selected resources, or preferred to be excluded. When given resources to include, UE-B may rely only on those resources, at least if it does not support sensing/resource exclusion, or may combine them with resources identified by its own sensing procedure, before making a final selection. The indication from UE-A to UE-B is sent in a medium access control (MAC) control element (CE) and/or 2nd-stage sidelink control information (SCI).

In IUC scheme 2, a UE-A can provide to another UE-B an indication that resources reserved for UE-B's transmission (which may or may not be to UE-A) will be, or could be, subject to conflict with a transmission from another UE. Then, UE-B
re-selects new resources to replace them. The indication from UE-A to UE-B may be sent in a physical sidelink feedback channel (PSFCH).

Sidelink communication in a high frequency band, e.g., millimeter wave band, offers a wide bandwidth and thus enables a high data rate. On the other hand, communication in a high frequency band suffers from a high path loss, and thus the communication range is rather limited. In order to compensate for the high path loss, beamforming with narrow beams or directional antennas is an effective way to provide sufficient communication range between two vehicles. But beamforming between the two vehicles in the sidelink communication is usually challenging. This is because, compared with beamforming in downlink/uplink between a base station and a UE, in which the base station typically does not move and is located at a higher elevation than the UE, the vehicles in the sidelink communication are sometimes moving and/or located at similar elevations. Due to these differences, the procedure for beamforming in downlink/uplink between a base station and a UE may not be applicable to beamforming between two UEs in a sidelink communication. Moreover, the procedure for beamforming in downlink/uplink between a base station and a UE, e.g., performing an exhaustive search for the best beam pair, may be too slow and may require too much battery power and may incur a significant procedure overhead and resource overhead. Improved systems and methods for beamforming in a sidelink communication are desired.

### SUMMARY OF INVENTION

According to some embodiments of the present disclosure, there is provided a method for a sidelink communication. The method includes: receiving, by a first UE in the sidelink communication, an IUC signal transmitted from a second UE; determining, by the first UE, a set of candidate radio resources for communication with the second UE based on the received IUC signal; determining, by the first UE, at least one direction associated with the received IUC signal based on an estimated angle-of-arrival of the received IUC signal; selecting, by the first UE, among a plurality of beams, at least one beam for communication with the second UE based on at least one of the determined at least one direction or a content of the received IUC signal; determining, by the first UE, a subset of radio resources from the set of candidate radio resources based on sensing on the selected at least one beam; and transmitting, by the first UE, the determined subset of radio resources to the second UE, or selecting, by the first UE, from the determined subset of radio resources, one or more radio resources for communication with the second UE.

According to some embodiments of the present disclosure, there is provided a UE for communications. The UE includes a memory storing an instruction; and a processor configured to execute the instruction stored in the memory to: receive an IUC signal transmitted from a second UE; determine a set of candidate radio resources for communication with the second UE based on the received IUC signal; determine at least one direction associated with the received IUC signal based on an estimation of an angle-of-arrival of the received IUC signal; select, among a plurality of beams, at least one beam for communication with the second UE based on at least one of the determined at least one direction or a content of the received IUC signal; determine a subset of radio resources from the set of candidate radio resources based on sensing on the selected at least one beam; and transmit the determined subset of radio resources to the second UE, or select, from the determined subset of radio resources, one or more radio resources for communication with the second UE.

According to some embodiments of the present disclosure, there is provided a non-transitory computer-readable medium storing instructions that are executable by one or more processors of a first UE for communication to perform a method. The method includes: receiving, by the first UE, an IUC signal transmitted from a second UE; determining, by the first UE, a set of candidate radio resources for communication with the second UE based on the received IUC signal; determining, by the first UE, at least one direction associated with the received IUC signal based on an estimated angle-of-arrival of the received IUC signal; selecting, by the first UE, among a plurality of beams, at least one beam for communication with the second UE based on at least one of the determined at least one direction or a content of the received IUC signal; determining, by the first UE, a subset of radio resources from the set of candidate radio resources based on sensing on the selected at least one beam; and transmitting, by the first UE, the determined subset of radio resources to the second UE, or selecting, by the first UE, from the determined subset of radio resources, one or more radio resources for communication with the second UE.

### BRIEF DESCRIPTION OF DRAWINGS

FIG. 1 is a schematic diagram illustrating an exemplary inter-UE coordination scheme in a communication system, consistent with some embodiments of the present disclosure.

FIG. 2 is a schematic diagram illustrating an exemplary beam alignment in the communication system of FIG. 1, consistent with some embodiments of the present disclosure.

FIG. 3 is a schematic diagram illustrating a joint inter-UE coordination and sidelink beam alignment in the communication system of FIG. 1, consistent with some embodiments of the present disclosure.

FIG. 4 is a schematic diagram illustrating an exemplary test setup to detect directional transmissions, consistent with some embodiments of the present disclosure.

FIG. 5 is a flow chart illustrating a method for beam alignment in a sidelink communication, consistent with some embodiments of the present disclosure.

FIG. 6 is a flow chart illustrating a method for detecting directional transmissions, consistent with some embodiments of the present disclosure.

FIG. 7 is a block diagram of a UE, consistent with some embodiments of the present disclosure.

### DESCRIPTION OF EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

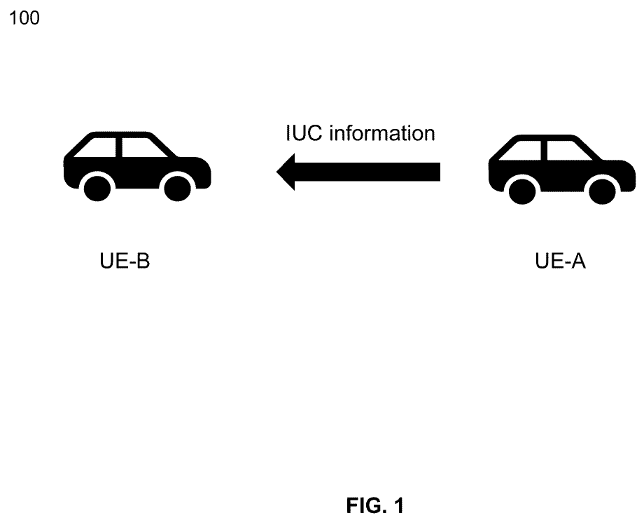

FIG. 1 is a schematic diagram illustrating an exemplary inter-UE coordination scheme (referred to as the “first IUC scheme” in this disclosure) in a sidelink communication system, consistent with some embodiments of the present disclosure. Referring to FIG. 1, a communication system 100 includes a first UE (UE-A) and a second UE (UE-B) that communicate with each other via a sidelink communication. For example, the sidelink communication may be a vehicle-to-everything (V2X) communication and both the UE-A and the UE-B are vehicles. The UE-B may be a transmitter (Tx) UE that is configured or programmed to transmit signals or data to the UE-A and/or other nodes (not shown) in the communication system 100. The other nodes may be a network node (e.g., a base station), a road side unit (RSU), a relay node, or other UEs in the communication system 100. The UE-A may be a receiver (Rx) UE that is configured or programmed to receive signals or data transmitted from the UE-B and/or the other nodes in the communication system 100.

In the first IUC scheme, before a transmission of signals and/or data from the UE-B, the UE-A may send coordination information (or inter-UE coordination (IUC) information) to the UE-B. The IUC information may be a set of resources preferred and/or non-preferred for the UE-B's transmission. In some embodiments, the transmission of the IUC information from the UE-A to the UE-B may be triggered by the UE-B. For example, the UE-B may trigger the transmission of the coordination information by sending a request for the IUC information to the UE-A. The request for the IUC information may be an explicit request or an implicit request.

In some embodiments, in the first IUC scheme, the transmission of the IUC information from the UE-A to the UE-B is triggered by an explicit request. For example, the UE-B may send a request to the UE-A to explicitly request the IUC information from the UE-A, and the UE-A may receive the explicit request from UE-B and send the IUC information to the UE-B. The transmission of the explicit request from UE-B and/or the reception of the explicit request by the UE-A may be enabled or disabled or controlled by configuration via a network or pre-configuration in the UE-B and/or the UE-A. In some embodiments, after receiving the IUC information, the UE-B may transmit signals and/or data (e.g., a transport block (TB)) to the UE-A. The UE-B may also transmit the signals and/or data to one or more other nodes, such as one or more other UEs. The transmission of the signals and/or data from the UE-B may be enabled or disabled or controlled by configuration or pre-configuration. UE-A and/or other nodes in the communication system may receive the signals and/or data transmitted from the UE-B. The reception of the signals and/or data by the UE-A may be enabled or disabled or controlled by configuration or pre-configuration.

In some embodiments, in the first IUC scheme, the transmission of the IUC information from the UE-A may be triggered by an implicit request received from UE-B. An example of an implicit request can be a condition to be satisfied by the UE-A. If the UE-A satisfies the condition, the UE-A may send the IUC information to the UE-B. The UE-B may receive the IUC information from the UE-A and use the IUC information for resource selection or re-selection. The IUC information may include resources preferred by the UE-B or not-preferred by the UE-B. The resources not-preferred by the UE-B may be the resources already occupied or reserved by other UEs. The resource selection or re-selection by the UE-B can be enabled or disabled or controlled by configuration via a network or pre-configuration at the UE-B.

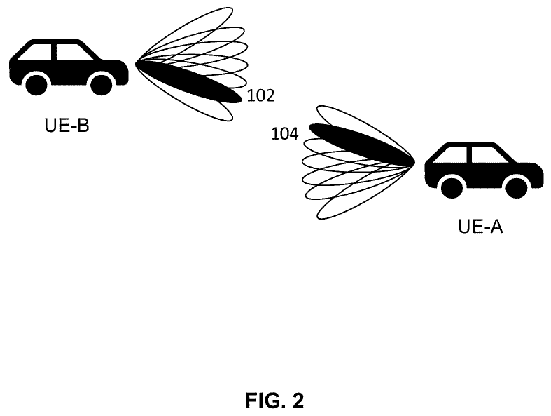

FIG. 2 is a schematic diagram illustrating an exemplary beamforming in the communication system of FIG. 1, consistent with some embodiments of the present disclosure. Referring to FIG. 2, the sidelink communication between the UE-A and the UE-B may be a beam-based communication. In this case, a sidelink beamforming is used so that a beam from UE-B (the oval 102 filled with the black color) and a beam from UE-A (the oval 104 filled with the black color) can be aligned. The term “beam alignment” and the term “beamforming” are used interchangeably in this disclosure. The beamforming at a transmitter UE (e.g., the UE-B) and/or a receiver UE (e.g., the UE-A) may increase communication range, achievable data rates on the sidelink, and overall system spectral efficiency by increasing spatial reuse of radio resources.

Referring to FIG. 2, both the UE-A and the UE-B may be located at a low elevation and may be moving. Also, in sidelink, each UE communicates with one or more UEs. This is different from an uplink/downlink formed by a UE and a base station (e.g., gNB, eNB) in which one end of the link (base station) typically does not move and is located at a higher elevation than the other end of the link (UE). Also, in uplink/downlink communication, each UE communicates with the base station only. Due to the differences, the sequential beam alignment procedure used in beamforming between a base station and a UE may not be applicable to beamforming in sidelink communication between the UE-A and the UE-B. Moreover, even if the procedure used in beamforming between a base station and a UE can be applied to beamforming in sidelink communication, the procedure for beamforming between a base station and a UE, for example, performing an exhaustive search for a best beam pair, may be too slow and may incur a significant overhead. For example, transmission and/or reception of reference signals using each possible beam pair during the search for the best beam may cause a significant overhead. At least some embodiments of the present disclosure address the above-noted issues of beamforming in sidelink communications.

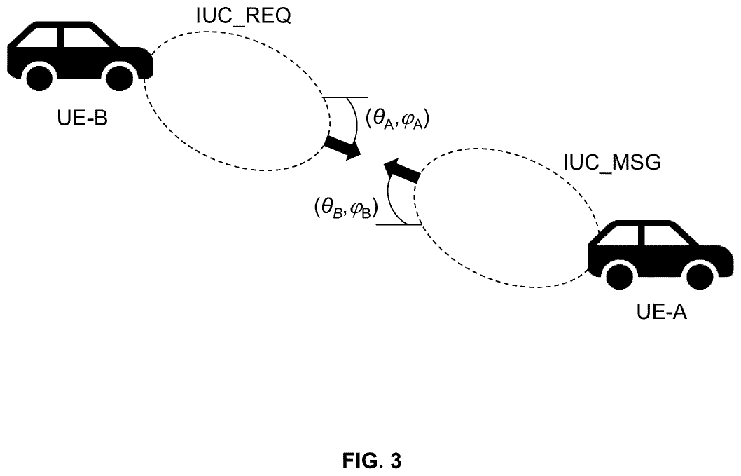

FIG. 3 is a schematic diagram illustrating a joint IUC and sidelink beamforming in the communication system of FIG. 1, consistent with some embodiments of the present disclosure. Referring to FIG. 3, both the UE-A and the
UE-B are ready to perform a sidelink beam alignment, and support and use the first IUC scheme. The UE-A and the UE-B may exchange signals for the first IUC scheme of the IUC. For example, the UE-B (Tx UE) may transmit an inter-UE coordination request (IUC_REQ) signal to the UE-A (Rx UE). In an embodiment, the UE-B may transmit an explicit request requesting IUC information. The IUC information may include a set of preferred or non-preferred radio resources for UE-B's resource selection and/or reselection. In an embodiment, the explicit request (or any implicit request) may be transmitted from the UE-B and received by the UE-A on FR2 spectrum. In the present disclosure, FR2 is defined by two frequency sub-ranges: FR2-1 from 24250 to 52600 MHz and FR2-2 from 52600 to 71000 MHz (including the millimeter wave spectrum). The FR2 signal may be transmitted using one or more FR2 antennas. In another embodiment, the explicit request (or any implicit request) may be transmitted from the UE-B and received by the UE-A on FR1 spectrum, e.g., based on an omnidirectional FR1 transmission and reception. In the present disclosure, FR1 is defined as a frequency range of from 410 to 7125 MHz (including the sub-6 GHz spectrum). The FR1 signal may be transmitted using one or more FR1 antennas. In some embodiments, generating a broad beam with an antenna panel used to generate a narrow beam (e.g., FR2) can be achieved by using a subset of antenna elements in the antenna panel. In some embodiments, a phase shift may be applied at each antenna element so that the beam becomes broader. In some embodiments, an IUC range may be increased by using a robust modulation coding scheme (MCS).

Upon reception of the inter-UE coordination request (IUC_REQ) signal, the UE-A may determine a direction-of-arrival (DoA) (θ_{B}, φ_{B}) of the incoming inter-UE coordination request (IUC_REQ) signal. The methods for determining a direction-of-arrival are well-established in art. For the sake of brevity, descriptions of the methods for determining a direction-of-arrival are omitted here. The angle θ_{B} may be an angle between x-axis and the incoming IUC_REQ signal, and the angle φ_{B} may be an angle between y-axis and the incoming IUC_REQ signal. In some embodiments, the UE-A may also determine an elevation angle (the angle between z-axis and the incoming IUC_REQ signal).

Based on the determined direction-of-arrival of the incoming inter-UE coordination request (IUC_REQ) signal, the UE-A may further select one or more Rx beams for a subsequent communication with the UE-B. For example, the UE-A may select one or more narrow Rx beams from among a plurality of narrow Rx beams for subsequent reception of data from the UE-B. In some embodiments, the UE-A may determine more than one direction-of-arrival of the incoming inter-UE coordination request (IUC_REQ) signal and select multiple Rx beam candidates based on the determination of the multiple direction-of-arrivals of the incoming inter-UE coordination request (IUC_REQ).

In some embodiments, the UE-A may perform channel sensing on the selected one or more Rx beams and determine the IUC information for UE-B based on the sensing result on the selected one or more Rx beams. The IUC information may include preferred or non-preferred resources for the UE-B.

In some embodiments, the UE-A may further transmit an inter-UE coordination message (IUC_MSG) to the UE-B. The IUC_MSG may include the IUC information determined by the UE-A. In an embodiment, the UE-A may determine multiple Rx beam candidates, and the IUC_MSG transmitted to the UE-B may contain preferred and/or non-preferred radio resources for each Rx beam candidate. In some embodiments, the IUC_MSG may be transmitted from the UE-A and received by the UE-B using a broad FR2 beam. In some embodiments, the IUC_MSG may be transmitted from the UE-A and received by the UE-B using an omnidirectional FR1 antenna. In an embodiment, based on reciprocity between the Tx beam and Rx beam, the transmission of the IUC_MSG by the UE-A may use one or more Rx beams already selected by the UE-A.

Upon receiving the IUC_MSG from the UE-A, the UE-B may determine a direction-of-arrival (θ_{A}, φ_{A}) of the incoming IUC_MSG signal, for example, using existing methods for direction-of-arrival estimation. The angle θ_{A} may be an angle between x-axis and the incoming IUC_MSG signal, and the angle φ_{A} may be an angle between y-axis and the incoming IUC_MSG signal. In some embodiments, the UE-B may also determine an elevation angle (the angle between z-axis and the incoming IUC_MSG signal). The UE-B may use the determined direction-of-arrival to select a Tx beam for a subsequent communication with the UE-A. For example, the UE-B may select one or more narrow Tx beams among a plurality of narrow Tx beams for subsequent transmission of data to the UE-A. In some embodiments, the UE-B may determine more than one direction-of-arrival of the IUC_MSG signal and select more than one Tx beam candidate based on the multiple direction-of-arrivals of the IUC_MSG signal.

In some embodiments, the UE-B may further perform channel sensing on the selected one or more Tx beams and select one or more resources based on the sensing result on the selected one or more Tx beams and the received IUC information. For example, the UE-B may avoid the selection of resources occupied or reserved by other UEs. In an embodiment, the UE-B may perform sensing on multiple Tx beam candidates and select a beam for transmission based on the sensing results obtained from sensing on the multiple Tx beam candidates and the received IUC_MSG. The UE-B may then transmit data to the UE-A in the selected one or more resources using the selected beam.

In an embodiment, the UE-A and the UE-B may exchange the IUC_REQ and IUC_MSG signals as part of NR sidelink Mode 2 resource selection as set forth in the 3GPP specification.

The method described above in relation to FIG. 3 is a joint IUC in which both UE-A and UE-B perform direction-of-arrival estimation. In some embodiments, only one UE (UE-A or UE-B) may perform direction-of-arrival estimation.

While the exemplary embodiments in the present disclosure relate to FR1 and FR2 communication, the application of the disclosed methods are not so limited. The methods described in this disclosure can be applied to any frequency bands, including the frequency bands used in current sidelink communications, and the frequency bands used in future generation (6^{th} generation (6G), 7^{th} generation (7G), or any future generation) sidelink communications. The methods described in this disclosure can also be applied to other systems, for example, downlink/uplink or wireless local area network, or any other system that complies with other standards (e.g., IEEE standards).

At least some embodiments of the disclosed methods are beneficial for the resource selection, as the sensing is performed on the beams that will actually be used for subsequent data transmission and/or reception. In addition, at least some embodiments of the disclosed methods are beneficial for beam alignment as the methods may allow for a fast beam alignment and reduced overhead, without performing an exhaustive beam search based on beam sweeping. Further, at least some embodiments of the disclosed method are also applicable to both the line-of-sight (LOS) and the non-line-of-sight (NLOS) channels, as the methods may rely on direction-of-arrival estimation rather than geometry (e.g., UE position).

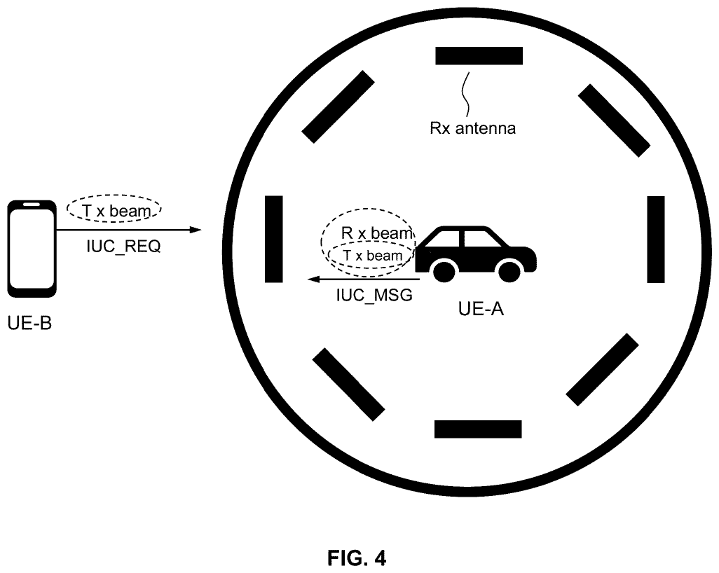

FIG. 4 is a schematic diagram illustrating an exemplary test setup 400 to detect directional transmissions, consistent with some embodiments of the present disclosure. Referring to FIG. 4, the test setup 400 includes two UEs, for example, a smartphone (UB-B) and a vehicle (UE-A). The UE-A is a UE being tested. The UE-A is deployed within a ring. An array of antennas is mounted on an inner wall of the ring such that the Rx beam and/or Tx beam of the UE-A is substantially perpendicular to a respective surface of each of the antennas. The two UEs may operate in FR2.

During the test, the UE-B is triggered to transmit an inter-UE coordination request (IUC-REQ) signal to UE-A. The IUC-REQ signal may be transmitted using a narrow or broad beam (e.g., FR2) or using an omnidirectional FR1 antenna. Referring to FIG. 4, for example, the UE-B utilizes a narrow beam. The incoming IUC-REQ signal may be substantially perpendicular to the outer surface of the ring. The UE-A receives the IUC-REQ and determines the direction-of-arrival of the incoming IUC-REQ signal.

Upon reception of the IUC-REQ signal, the UE-A transmits an inter-UE coordination message (IUC-MSG). For the transmission of the IUC-MSG, the UE-A applies a beam which matches the direction-of-arrival of the UE-B's transmission of the IUC-REQ signal. In this case, the antenna array mounted on the ring can detect the transmission direction of the IUC-MSG signal from the UE-A. The detection of the IUC-MSG signal by one or more antennas of the antenna array on the ring surface indicates that the UE-A practices the methods disclosed in this disclosure.

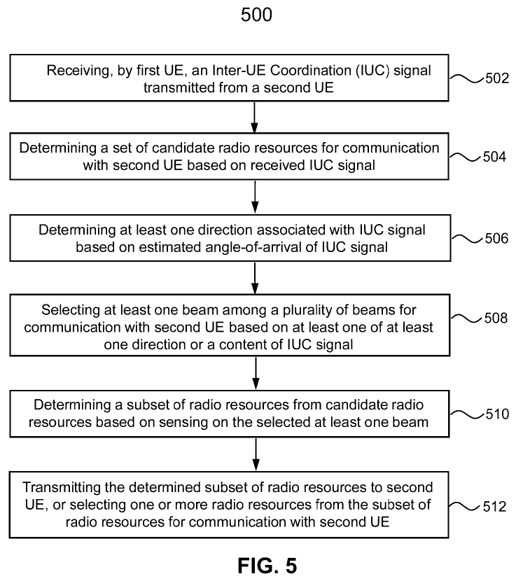

FIG. 5 is a flow chart illustrating a method 500 (e.g., for beam alignment and resource (re-)selection) in a sidelink communication, consistent with some embodiments of the present disclosure. The method 500 may be performed by a UE in a sidelink communication. For example, the method 500 may be performed by a vehicle in a V2X communication.

Referring to FIG. 5, the method 500 includes a step 502 of receiving, by a first UE in the sidelink communication, an inter-UE coordination (IUC) signal transmitted from a second UE.

In one embodiment, the first UE may be a transmitter UE in a sidelink communication, such as the UE-B of FIG. 3, and the IUC signal may be an inter-UE coordination message signal, such as the IUC_MSG signal of FIG. 3. The first UE may receive the IUC signal using at least one of FR2 or FR1. The IUC message signal may include at least one of: a set of preferred radio resources for transmission of a signal or data from the first UE, or a set of non-preferred radio resources for transmission of a signal or data from the first UE. In this embodiment, before reception of the IUC message signal, the first UE may transmit an IUC request signal to the second UE to request the IUC message, and receive the IUC message signal in response to the transmission of the IUC request signal. The IUC request can be an explicit request or an implicit request. In this case, one or more beams used for receiving the IUC message signal from the second UE and one or more beams used for transmitting the IUC request signal may have reciprocity.

In another embodiment, the first UE is a receiver UE in a sidelink communication, such as the UE-A of FIG. 3, and the IUC signal is an IUC request signal. The first UE may receive the IUC request signal using at least one of FR2 or FR1. In this embodiment, after receiving the IUC request signal, the first UE may transmit an IUC message signal to the second UE. The IUC message signal transmitted from the first UE may include at least one of: a set of preferred radio resources for transmission of a signal or data from the second UE, or a set of non-preferred radio resources for transmission of a signal or data from the second UE. The one or more beams used for transmitting the IUC message signal from the first UE and one or more beams used for receiving the IUC request signal may have reciprocity.

The method 500 includes a step 504 of determining, by the first UE, a set of candidate radio resources for communication with the second UE based on the received IUC signal.

In one embodiment, the first UE is a transmitter UE in the sidelink communication, such as the UE-B of FIG. 3, and the IUC signal is an IUC message signal. In this embodiment, based on the received IUC message signal, the first UE may determine a set of candidate radio resources for transmission of data or signal to the second UE. The first UE may determine the candidate resources based on the IUC message signal received from the second UE. In addition, the first UE may also perform its own channel sensing and consider the channel sensing results. The transmission of the signal or the data may be a broadcast, multicast, or unicast to the second UE.

In another embodiment, the first UE is a receiver UE in the sidelink communication, such as the UE-A of FIG. 3, and the IUC signal is an IUC request signal. In this embodiment, upon reception of the IUC request signal, the first UE may determine a set of candidate radio resources for communication with the second UE. Alternatively, in this embodiment, the step 504 is not performed.

The method 500 includes a step 506 of determining, by the first UE, at least one direction associated with the received IUC signal based on an estimated angle-of-arrival of the IUC signal.

In one embodiment, the first UE is a transmitter UE in the sidelink communication, such as the UE-B of FIG. 3, and the IUC signal is an IUC message signal. In this embodiment, the first UE may determine at least one direction associated with the received IUC message signal based on an estimated angle-of-arrival of the incoming IUC message. The estimated angles may be one or more angles between the IUC message signal direction and the x-axis, y-axis, z-axis, or any other reference axis.

In another embodiment, the first UE is a receiver UE in the sidelink communication, such as the UE-A of FIG. 3, and the IUC signal is an IUC request signal. In this embodiment, the first UE may determine at least one direction associated with the received IUC request signal based on an estimated angle-of-arrival of the incoming IUC request signal. The estimated angles may be one or more angles between the IUC request signal direction and the x-axis, y-axis, z-axis, or any other reference axis.

The method 500 includes a step 508 of selecting, by the first UE, at least one beam among a plurality of beams for communication with the second UE based on at least one of: the determined at least one direction, or a content of the received IUC signal.

In one embodiment, the first UE is a transmitter UE in the sidelink communication, such as the UE-B of FIG. 3, and the IUC signal is an IUC message signal. In this embodiment, the first UE may select at least one beam (Tx beam) among a plurality of beams for transmission based on the determined direction associated with the received IUC message signal and/or a content of the IUC message signal (e.g., preferred resources or non-preferred resources for the first UE).

In another embodiment, the first UE is a receiver UE in the sidelink communication, such as the UE-A of FIG. 3, and the IUC signal is an IUC request signal. In this embodiment, the first UE may select at least one beam (Rx beam) from a plurality of beams for subsequent reception of data or signals from the second UE. In this embodiment, the first UE may select the at least one beam (Rx beam) based on the determined direction associated with the received IUC request signal and/or the content of the IUC request signal.

The method 500 includes a step 510 of determining, by the first UE, a subset of radio resources from the set of candidate radio resources based on sensing on the selected at least one beam.

In one embodiment, the first UE is a transmitter UE in the sidelink communication, such as the UE-B of FIG. 3, and the IUC signal is an IUC message signal. In this embodiment, the first UE may perform sensing on the selected at least one beam (Tx beam) and determine a subset of radio resources from the candidate radio resources based on the sensing results.

In another embodiment, the first UE is a receiver UE in the sidelink communication, such as the UE-A of FIG. 3, and the IUC signal is an IUC request signal. In this embodiment, the first UE may perform sensing on the selected at least one Rx beam and determine a subset of radio resources from among the candidate radio resources based on the sensing results. In this embodiment, the first UE may perform the sensing in order to determine the inter-UE coordination information (e.g., preferred or non-preferred resources) for the second UE.

The method 500 includes a step 512 of transmitting, by the first UE, the determined subset of radio resources to the second UE, or selecting, by the first UE, from the determined subset of radio resources, one or more radio resources for communication with the second UE.

In an embodiment, the first UE is a transmitter UE in the sidelink communication, such as the UE-B of FIG. 3, and the IUC signal is an IUC message signal. In this embodiment, the first UE may transmit the determined subset of radio resources to the second UE. Alternatively, the first UE may select one or more radio resources from the determined subset of radio resources for communication with the second UE.

In another embodiment, the first UE is a receiver UE in the sidelink communication, such as the UE-A of FIG. 3, and the IUC signal is IUC request signal. In this embodiment, the first UE may transmit the determined subset of radio resources to the second UE, or select one or more radio resources from the determined subset of radio resources for communication with the second UE. Alternatively, in this embodiment, the step 512 may not be performed.

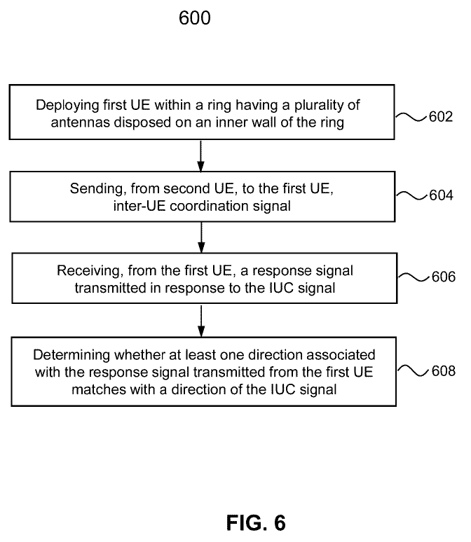

FIG. 6 is a flow chart illustrating a method 600 for detecting directional transmissions, consistent with some embodiments of the present disclosure. The method 600 may be performed by two UEs in a sidelink communication. For example, the method 600 may be performed by a transmitter UE and a receiver UE in a sidelink communication in the exemplary test setup of FIG. 4.

Referring to FIG. 6, the method 600 includes a step 602 of deploying a first UE within a ring having a plurality of antennas disposed on an inner wall of the ring. The first UE is a UE being tested to determine whether it practices the method of FIG. 5. The first UE may be capable of operating in FR2 beam. The first UE may be a receiver UE (e.g., UE-A in FIG. 3) in a sidelink communication. The first UE may be UE-A shown in FIG. 4.

The method 600 includes a step 604 of sending, from a second UE, to the first UE, an inter-UE coordination (IUC) signal. The IUC signal may be an IUC request signal transmitted from the second UE. The IUC request signal can be transmitted using a narrow beam or a broad beam. The second UE may or may not practice the method of FIG. 5. The second UE may be capable of operating in FR2 beam. The second UE may be UE-B shown in FIG. 6.

The method 600 includes a step 606 of receiving, from the first UE, a response signal transmitted in response to the IUC signal. In an example where the first UE practices the method of FIG. 5, upon reception of the IUC signal (e.g., an IUC request signal), the first UE determines the direction-of-arrival of the IUC signal. The first UE further transmits a response signal (e.g., an IUC message signal) using a beam that matches with the direction-of-arrival of the IUC signal.

The method 600 includes a step 608 of determining whether at least one direction associated with the response signal transmitted from the first UE matches with a direction of the IUC signal. If at least one direction associated with the response signal determined by one or more antennas on the inner wall of the ring matches with the direction of the IUC signal, it can be concluded that the first UE practices the method of FIG. 5.

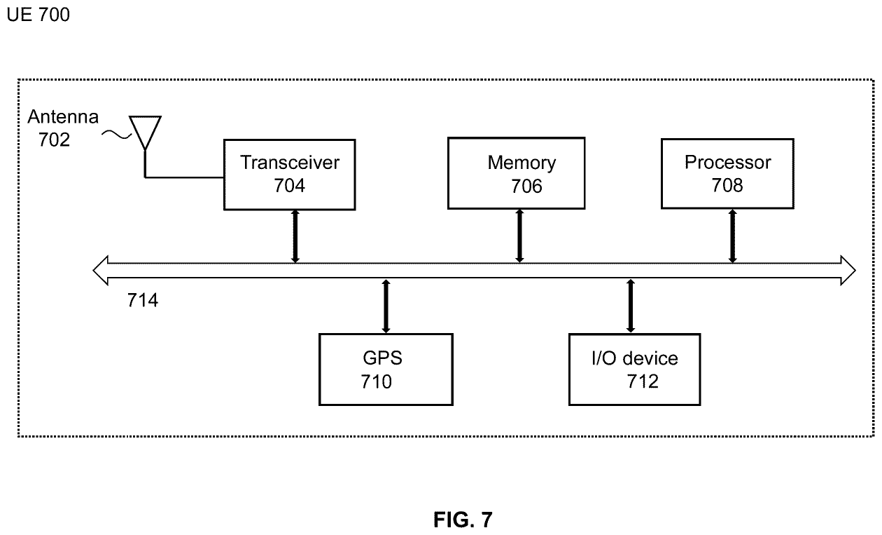

FIG. 7 is a block diagram of a UE 700, consistent with some embodiments of the present disclosure. The UE 700 can be a transmitter UE in a sidelink communication, such as the UE-B of FIG. 3, or a receiver UE in a sidelink communication, such as the UE-A of FIG. 3. The UE 700 may take any form, including but not limited to, a vehicle, a component mounted in a vehicle, a laptop computer, a wireless terminal including a mobile phone, a wireless handheld device, or wireless personal device, or any other form. Referring to FIG. 7, the UE 700 may include antenna 702 that may be used for transmission or reception of electromagnetic signals to/from other nodes such as a network node (e.g., a base station), a RSU, a relay node, or other UEs. The antenna 702 can be an FR1 antenna configured to transmit and/or receive an FR1 signal. Alternatively, or additionally, the antenna 702 can be an FR2 antenna configured to transmit and/or receive an FR2 signal. The Antenna 702 may include one or more antenna elements and may enable different input-output antenna configurations, for example, multiple input multiple output (MIMO) configuration, multiple input single output (MISO) configuration, and single input multiple output (SIMO) configuration. In some embodiments, the antenna 702 may include multiple (e.g., tens or hundreds) antenna elements and may enable multi-antenna functions such as beamforming. In some embodiments, the antenna 702 is a single antenna.

The UE 700 may include a transceiver 704 that is coupled to the antenna 702. The transceiver 704 may be a wireless transceiver at the UE 700 and may communicate bi-directionally with a base station or other UEs. For example, the transceiver 704 may receive/transmit wireless signals from/to a base station via downlink/uplink communication. The transceiver 704 may also receive/transmit wireless signals from/to another UE or RSU via sidelink communication. The transceiver 704 may include a modem to modulate the packets and provide the modulated packets to the antenna 702 for transmission, and to demodulate packets received from the antenna 702.

The UE 700 may include a memory 706. The memory 706 may be any type of computer-readable storage medium including volatile or non-volatile memory devices, or a combination thereof. The computer-readable storage medium includes, but is not limited to, non-transitory computer storage media. A non-transitory storage medium may be accessed by a general purpose or special purpose computer. Examples of non-transitory storage medium include, but are not limited to, a portable computer diskette, a hard disk, random access memory (RAM), read-only memory (ROM), an erasable programmable read-only memory (EPROM), electrically erasable programmable ROM (EEPROM), a digital versatile disk (DVD), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable medium.

The memory 706 may store information related to identities of UE 700 and the signals and/or data received by antenna 702. The memory 706 may also store post-processing signals and/or data. The memory 706 may also store computer-readable program instructions, mathematical models, and algorithms that are used in signal processing in transceiver 704 and computations in processor 708. For example, the memory 706 may store computer-readable program instructions, mathematical models, and algorithms that are used for estimation of the angle-of-arrival of the IUC request signal and/or the angle-of-arrival of the IUC message signal. The memory 706 may further store computer-readable program instructions for execution by processor 708 to operate UE 700 to perform various functions described in this disclosure. In some examples, the memory 706 may include a basic input/output system (BIOS) which may control basic hardware or software operation such as the interaction with peripheral components or devices. In some embodiments, the memory 706 includes both LTE and NR modules. In some other embodiments, the memory 706 includes an NR module only. In some other embodiments, the memory 706 includes an LTE module only.

The computer-readable program instructions of the present disclosure may be assembler instructions, instruction-set-architecture (ISA) instructions, machine instructions, machine-dependent instructions, microcode, firmware instructions, state-setting data, or source code or object code written in any combination of one or more programming languages, including an object-oriented programming language, and conventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a local area network (LAN) or a wide area network (WAN).

The UE 700 may include a processor 708 that may include a hardware device with processing capabilities. The processor 708 may include at least one of a general-purpose processor, a digital signal processor (DSP), a central processing unit (CPU), a microcontroller, an application specific integrated circuit (ASIC), a field programmable gate array (FPGA), a programmable logic device, a discrete gate or transistor logic component, a discrete hardware component, or other programmable logic device. Examples of the general-purpose processor include, but are not limited to, a microprocessor, any conventional processor, a controller, a microcontroller, or a state machine. In some embodiments, the processor 708 may be implemented using a combination of devices (e.g., a combination of a DSP and a microprocessor, multiple microprocessors, one or more microprocessors in conjunction with a DSP core, or any other such configuration). The processor 708 may receive, from transceiver 704, downlink signals or sidelink signals and further process the signals. The processor 708 may also receive, from transceiver 704, data packets and further process the packets. In some embodiments, the processor 708 may be configured to operate a memory using a memory controller. In some embodiments, a memory controller may be integrated into the processor 708. The processor 708 may be configured to execute computer-readable instructions stored in a memory (e.g., the memory 706) to cause the UE 700 to perform various functions.

The UE 700 may include a global positioning system (GPS) 710. The GPS 710 may be used for enabling location-based services or other services based on a geographical position of the UE 700 and/or synchronization among UEs. The GPS 710 may receive global navigation satellite systems (GNSS) signals from a single satellite or a plurality of satellite signals via the antenna 702 and provide a geographical position of the UE 700 (e.g., coordinates of the UE 700). In some embodiment, the GPS 710 may be omitted.

The UE 700 may include an input/output (I/O) device 712 that may be used to communicate a result of signal processing and computation to a user or another device. The I/O device 712 may include a user interface including a display and an input device to transmit a user command to processor 708. The display may be configured to display a status of signal reception at the UE 700, the data stored at memory 706, a status of signal processing, and a result of computation, etc. The display may include, but is not limited to, a cathode ray tube (CRT), a liquid crystal display (LCD), a light-emitting diode (LED), a gas plasma display, a touch screen, or other image projection devices for displaying information to a user. The input device may be any type of computer hardware equipment used to receive data and control signals from a user. The input device may include, but is not limited to, a keyboard, a mouse, a scanner, a digital camera, a joystick, a trackball, cursor direction keys, a touchscreen monitor, or audio/video commanders, etc.

The UE 700 may further include a machine interface 714, such as an electrical bus that connects the transceiver 704, the memory 706, the processor 708, the GPS 710, and the I/O device 712.

In some embodiments, the UE 700 may be configured to or programmed for sidelink communications. For example, the UE 700 may be a transmitter UE or a receiver UE in a sidelink communication, and the processor 708 may be configured to execute the instructions stored in the memory 706 to receive an IUC signal transmitted from a second UE; determine a set of candidate radio resources for communication with the second UE based on the received IUC signal; determine at least one direction associated with the received IUC signal based on an estimation of an angle-of-arrival of the received IUC signal; select, among a plurality of beams, at least one beam for communication with the second UE based on at least one of the determined at least one direction or a content of the received IUC signal; determine a subset of radio resources from the set of candidate radio resources based on sensing on the selected at least one beam; and transmit the determined subset of radio resources to the second UE, or select, from the determined subset of radio resources, one or more radio resources for communication with the second UE.

As used in this disclosure, use of the term “or” in a list of items indicates an inclusive list. The list of items may be prefaced by a phrase such as “at least one of” or “one or more of”. For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise”, “include” or “contain” may be used interchangeably and have the same meaning and are to be construed as inclusive and open-ended. The terms “comprise”, “include” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

It will be further understood that various modifications, alternatives and variations in the details, materials, and arrangements of the parts which have been described and illustrated in order to explain the nature of described embodiments may be made by those skilled in the art without departing from the scope. Accordingly, the following claims embrace all such alternatives, modifications and variations that fall within the terms of the claims.

Clause 1. A first user equipment (UE) for communications, the first UE comprising:
a memory storing an instruction; and
a processor configured to execute the instruction stored in the memory to:
receive an inter-UE coordination (IUC) signal transmitted from a second UE;
determine a set of candidate radio resources for communication with the second UE based on the received IUC signal;
determine at least one direction associated with the received IUC signal based on an estimation of an angle-of-arrival of the received IUC signal;
select, among a plurality of beams, at least one beam for communication with the second UE based on at least one of the determined at least one direction or a content of the received IUC signal;
determine a subset of radio resources from the set of candidate radio resources based on sensing on the selected at least one beam; and
transmit the determined subset of radio resources to the second UE, or select, from the determined subset of radio resources, one or more radio resources for communication with the second UE.

Clause 2. The first UE of clause 1, wherein the angle-of-arrival of the received IUC signal comprises at least one of an angle between x-axis and an incoming IUC signal direction or an angle between y-axis and the incoming IUC signal direction.

Clause 3. The first UE of clause 1, wherein the first UE is a transmitter UE in a sidelink communication, the IUC signal is an IUC message signal, and the processor is further configured to execute the instruction stored in the memory to:
transmit, to the second UE, an IUC request signal.

Clause 4. The first UE of clause 3, wherein the IUC request signal is transmitted using at least one of FR2 or FR1.

Clause 5. The first UE of clause 3, wherein one or more beams used for receiving the IUC message signal from the second UE and one or more beams used for transmitting the IUC request signal have reciprocity.

Clause 6. The first UE of clause 1, wherein the first UE is a transmitter UE in a sidelink communication and the IUC signal is an IUC message signal, and wherein the IUC message signal comprises at least one of: (a) a set of preferred radio resources for transmission of a signal or data from the first UE, or (b) a set of non-preferred radio resources for transmission of a signal or data from the first UE.

Clause 7. The first UE of clause 1, wherein the first UE is a transmitter UE in a sidelink communication, and the processor is further configured to execute the instruction stored in the memory to:
transmit, to the second UE, a signal or data using the selected one or more radio resources.

Clause 8. The first UE of clause 1, wherein the first UE is a receiver UE in a sidelink communication, the IUC signal is an IUC request signal, and the processor is further configured to execute the instruction stored in the memory to:
transmit, to the second UE, an IUC message signal.

Clause 9. The first UE of clause 8, wherein the IUC message signal comprises at least one of: (a) a set of preferred radio resources for transmission of a signal or data from the second UE, or (b) a set of non-preferred radio resources for transmission of a signal or data from the second UE.

Clause 10. The first UE of clause 8, wherein one or more beams used for transmitting the IUC message signal from the first UE and one or more beams used for receiving the IUC request signal have reciprocity.

Clause 11. The first UE of clause 8, wherein the IUC message signal is transmitted using at least one of FR2 or FR1.

Clause 12. The first UE of clause 8, wherein the processor is further configured to execute the instruction stored in the memory to:
receive, from the second UE, a signal or data transmitted based on at least one of the at least one direction or a content of the IUC message signal.

Clause 13. The first UE of clause 1, wherein the set of candidate radio resources comprise one or more sub-channels or one or more slots for a sidelink communication.

Clause 14. A method in a sidelink communication, the method comprising:
receiving, by a first user equipment (UE) in the sidelink communication, an inter-UE coordination (IUC) signal transmitted from a second UE;
determining, by the first UE, a set of candidate radio resources for communication with the second UE based on the received IUC signal;
determining, by the first UE, at least one direction associated with the received IUC signal based on an estimated angle-of-arrival of the received IUC signal;
selecting, by the first UE, among a plurality of beams, at least one beam for communication with the second UE based on at least one of the determined at least one direction or a content of the received IUC signal;
determining, by the first UE, a subset of radio resources from the set of candidate radio resources based on sensing on the selected at least one beam; and
transmitting, by the first UE, the determined subset of radio resources to the second UE, or selecting, by the first UE, from the determined subset of radio resources, one or more radio resources for communication with the second UE.

Clause 15. The method of clause 14, wherein the angle-of-arrival of the received IUC signal comprises at least one of an angle between x-axis and an incoming IUC signal direction or an angle between y-axis and the incoming IUC signal direction.

Clause 16. The method of clause 14, wherein the first UE is a transmitter UE in the sidelink communication, the IUC signal is an IUC message signal, and the method further comprises:
transmitting, to the second UE, an IUC request signal before receiving the IUC message signal.

Clause 17. The method of clause 16, wherein the IUC request signal is transmitted using at least one of FR2 or FR1.

Clause 18. The method of clause 16, wherein one or more beams used for receiving the IUC message signal from the second UE and one or more beams used for transmitting the IUC request signal have reciprocity.

Clause 19. The method of clause 14, wherein the first UE is a transmitter UE in the sidelink communication and the IUC signal is an IUC message signal, and wherein the IUC message signal comprises at least one of: (a) a set of preferred radio resources for transmission of a signal or data from the first UE, or (b) a set of non-preferred radio resources for transmission of a signal or data from the first UE.

Clause 20. The method of clause 14, wherein the first UE is a transmitter UE in the sidelink communication, and the method further comprises:
transmitting, to the second UE, a signal or data using the selected one or more radio resources.

Clause 21. The method of clause 14, wherein the first UE is a receiver UE in the sidelink communication and the IUC signal is an IUC request signal, and the method further comprises:
transmitting, to the second UE, an IUC message signal.

Clause 22. The method of clause 21, wherein the IUC message signal is transmitted using at least one of FR2 or FR1.

Clause 23. The method of clause 21, wherein the IUC message signal comprises at least one of: (a) a set of preferred radio resources for transmission of a signal or data from the second UE, or (b) a set of non-preferred radio resources for transmission of a signal or data from the second UE.

Clause 24. The method of clause 21, wherein one or more beams used for transmitting the IUC message signal from the first UE and one or more beams used for receiving the IUC request signal have reciprocity.

Clause 25. The method of clause 21, further comprising:
receiving, from the second UE, a signal or data transmitted based on at least one of the at least one direction or a content of the IUC message signal.

Clause 26. The method of clause 14, wherein the set of candidate radio resources comprise one or more sub-channels or one or more slots for the sidelink communication.

Clause 27. A non-transitory computer-readable medium storing instructions that are executable by one or more processors of a first user equipment (UE) for communication, to perform a method, the method comprising:
receiving, by the first UE, an inter-UE coordination (IUC) signal transmitted from a second UE;
determining, by the first UE, a set of candidate radio resources for communication with the second UE based on the received IUC signal;
determining, by the first UE, at least one direction associated with the received IUC signal based on an estimated angle-of-arrival of the received IUC signal;
selecting, by the first UE, among a plurality of beams, at least one beam for communication with the second UE based on at least one of the determined at least one direction or a content of the received IUC signal;
determining, by the first UE, a subset of radio resources from the set of candidate radio resources based on sensing on the selected at least one beam; and
transmitting, by the first UE, the determined subset of radio resources to the second UE, or selecting, by the first UE, from the determined subset of radio resources, one or more radio resources for communication with the second UE.

1. A first user equipment (UE) for communications, the first UE comprising:
a memory storing an instruction; and
a processor configured to execute the instruction stored in the memory to:
receive an inter-UE coordination (IUC) signal transmitted from a second UE;
determine a set of candidate radio resources for communication with the second UE based on the received IUC signal;
determine at least one direction associated with the received IUC signal based on an estimation of an angle-of-arrival of the received IUC signal;
select, among a plurality of beams, at least one beam for communication with the second UE based on at least one of the determined at least one direction or a content of the received IUC signal;
determine a subset of radio resources from the set of candidate radio resources based on sensing on the selected at least one beam; and
transmit the determined subset of radio resources to the second UE, or select, from the determined subset of radio resources, one or more radio resources for communication with the second UE.

2. The first UE of claim 1, wherein the angle-of-arrival of the received IUC signal comprises at least one of an angle between x-axis and an incoming IUC signal direction or an angle between y-axis and the incoming IUC signal direction.

3. The first UE of claim 1, wherein the first UE is a transmitter UE in a sidelink communication, the IUC signal is an IUC message signal, and the processor is further configured to execute the instruction stored in the memory to:
transmit, to the second UE, an IUC request signal.

4. The first UE of claim 3, wherein the IUC request signal is transmitted using at least one of FR2 or FR1.

5. The first UE of claim 3, wherein one or more beams used for receiving the IUC message signal from the second UE and one or more beams used for transmitting the IUC request signal have reciprocity.

6. The first UE of claim 1, wherein the first UE is a transmitter UE in a sidelink communication and the IUC signal is an IUC message signal, and wherein the IUC message signal comprises at least one of: (a) a set of preferred radio resources for transmission of a signal or data from the first UE, or (b) a set of non-preferred radio resources for transmission of a signal or data from the first UE.

7. The first UE of claim 1, wherein the first UE is a transmitter UE in a sidelink communication, and the processor is further configured to execute the instruction stored in the memory to:
transmit, to the second UE, a signal or data using the selected one or more radio resources.

8. The first UE of claim 1, wherein the first UE is a receiver UE in a sidelink communication, the IUC signal is an IUC request signal, and the processor is further configured to execute the instruction stored in the memory to:
transmit, to the second UE, an IUC message signal.

9. The first UE of claim 8, wherein the IUC message signal comprises at least one of: (a) a set of preferred radio resources for transmission of a signal or data from the second UE, or (b) a set of non-preferred radio resources for transmission of a signal or data from the second UE.

10. The first UE of claim 8, wherein one or more beams used for transmitting the IUC message signal from the first UE and one or more beams used for receiving the IUC request signal have reciprocity.

11. The first UE of claim 8, wherein the processor is further configured to execute the instruction stored in the memory to:
receive, from the second UE, a signal or data transmitted based on at least one of the at least one direction or a content of the IUC message signal.

12. The first UE of claim 1, wherein the set of candidate radio resources comprise one or more sub-channels or one or more slots for a sidelink communication.

13. A method in a sidelink communication, the method comprising:
receiving, by a first user equipment (UE) in the sidelink communication, an inter-UE coordination (IUC) signal transmitted from a second UE;
determining, by the first UE, a set of candidate radio resources for communication with the second UE based on the received IUC signal;
determining, by the first UE, at least one direction associated with the received IUC signal based on an estimated angle-of-arrival of the received IUC signal;
selecting, by the first UE, among a plurality of beams, at least one beam for communication with the second UE based on at least one of the determined at least one direction or a content of the received IUC signal;
determining, by the first UE, a subset of radio resources from the set of candidate radio resources based on sensing on the selected at least one beam; and
transmitting, by the first UE, the determined subset of radio resources to the second UE, or selecting, by the first UE, from the determined subset of radio resources, one or more radio resources for communication with the second UE.

14. The method of claim 13, wherein the angle-of-arrival of the received IUC signal comprises at least one of an angle between x-axis and an incoming IUC signal direction or an angle between y-axis and the incoming IUC signal direction.

15. The method of claim 13, wherein the first UE is a transmitter UE in the sidelink communication, the IUC signal is an IUC message signal, and the method further comprises:
transmitting, to the second UE, an IUC request signal before receiving the IUC message signal.

16. The method of claim 13, wherein the first UE is a transmitter UE in the sidelink communication and the IUC signal is an IUC message signal, and wherein the IUC message signal comprises at least one of: (a) a set of preferred radio resources for transmission of a signal or data from the first UE, or (b) a set of non-preferred radio resources for transmission of a signal or data from the first UE.

17. The method of claim 13, wherein the first UE is a transmitter UE in the sidelink communication, and the method further comprises:
transmitting, to the second UE, a signal or data using the selected one or more radio resources.

18. The method of claim 13, wherein the first UE is a receiver UE in the sidelink communication and the IUC signal is an IUC request signal, and the method further comprises:
transmitting, to the second UE, an IUC message signal.

19. The method of claim 13, wherein the set of candidate radio resources comprise one or more sub-channels or one or more slots for the sidelink communication.

20. A non-transitory computer-readable medium storing instructions that are executable by one or more processors of a first user equipment (UE) for communication, to perform a method, the method comprising:
receiving, by the first UE, an inter-UE coordination (IUC) signal transmitted from a second UE;
determining, by the first UE, a set of candidate radio resources for communication with the second UE based on the received IUC signal;
determining, by the first UE, at least one direction associated with the received IUC signal based on an estimated angle-of-arrival of the received IUC signal;
selecting, by the first UE, among a plurality of beams, at least one beam for communication with the second UE based on at least one of the determined at least one direction or a content of the received IUC signal;
determining, by the first UE, a subset of radio resources from the set of candidate radio resources based on sensing on the selected at least one beam; and
transmitting, by the first UE, the determined subset of radio resources to the second UE, or selecting, by the first UE, from the determined subset of radio resources, one or more radio resources for communication with the second UE.
